(19) United States
(12) Patent Application Publication
(10) Pub. No.: US 2025/0177816 A1
(43) Pub. Date: Jun. 5, 2025

(54) METHODS AND SYSTEMS FOR INDIVIDUALIZED TRAINING

(71) Applicant: Movement Health Science, Inc., Mountain View, CA (US)

(72) Inventors: Douglas Hoogendyk, Prairie Village, KS (US); Alex Lash, Charlotte, NC (US); Jason Antico, Erie, CO (US); Todd Norwood, Redwood City, CA (US); John Marsden, Narrawallee (AU); Mark Stout, Santa Cruz, CA (US); Dave Merriwether, Portland, OR (US); Armand Indra, Los Angeles, CA (US); Kendra Sato, Gilroy, CA (US)

(21) Appl. No.: 18/969,155

(22) Filed: Dec. 4, 2024

Related U.S. Application Data
(60) Provisional application No. 63/606,548, filed on Dec. 5, 2023.

(51) Int. Cl. A63B 24/00

(52) U.S. Cl. CPC A63B 24/0062; A63B 24/0075; A63B 2024/0065; A63B 2230/01

(57) ABSTRACT

Methods and systems are provided for capturing and analyzing movement. In one example the system includes a user device, a data collection device communicatively coupled to the user device, a processor configured with instructions stored on non-transitory memory that, when executed, cause the processor to: receive user characterization input of a subject; receive, from the data collection device, one or more of one or more evaluation movements of the subject captured by the data collection device, and measured movement features; automatically output one or more biomechanical scores, each biomechanical score based on more than one measured movement features; output a comprehensive score based on the one or more biomechanical scores, the comprehensive score indicative of a physical ability of the subject; and output a training program, where the training program is individualized to the subject and configured to increase the comprehensive score of the subject.

### CROSS REFERENCE TO RELATED APPLICATIONS

The present application claims priority to U.S. Provisional Application No. 63/606,548 entitled “METHODS AND SYSTEMS FOR INDIVIDUALIZED TRAINING” and filed on Dec. 5, 2023. The entire contents of the above-identified application are hereby incorporated by reference for all purposes.

### FIELD

The present descriptions relate generally to methods and systems for analyzing movement to provide objective scoring outputs and athletic training based on those outputs to an individual.

### BACKGROUND/SUMMARY

In the field of athletics, there are limitations of current movement analysis methods and systems including a demand for specialized technical equipment, a large quantity of measurements, and expert interpretation. Many systems provide information related to movement or training quantity, and are often referred to as load management (e.g., training volume and intensity) systems. However, quantitative information regarding qualitative aspects of an athlete's movement, such as structural ability to perform certain movements, may not be output by currently available systems.

Further, an individualized training program that is directed towards strengths and weaknesses of an individual athlete as well as their specific sport may be desired. Existing solutions to providing individualized training programs often demand use of specialized motion capture equipment and/or sensors that are worn by the user. Additionally, measurements output by the specialized equipment may demand analysis by a skilled professional before any actionable results, such as a personalized training program can be obtained. Additionally, existing solutions may not include quantitative outputs that may be used objectively and repeatedly to compare between users or monitor a user's progress over time.

Athletes typically follow a training program to condition the mind and body in order to enhance performance in a sport or other athletic pursuit. In response to overuse symptoms or an actual injury, the athlete may reduce the amount of time spent in training or adjust types of movements done during training. Adjusting the training program in response to an injury is less desirable than adjusting the training program in order to reduce the likelihood of overuse symptoms or injury.

In one embodiment, the issues described above have been recognized by the inventors and may be at least partially addressed by, a system including a data collection device communicatively coupled to the user device, and a processor configured with instructions stored on non-transitory memory that, when executed, cause the processor to receive user characterization input, receive, from the data collection device, one or more of one or more evaluation movements inputs captured by the data collection device and measured movement features, automatically output one or more biomechanical scores and potential physical risk observations, each biomechanical score based on more than one measured movement feature, output a comprehensive score based on the one or more biomechanical scores, the comprehensive score indicative of a physical ability of the subject, and output a training program, the training program individualized to the subject and configured to increase the comprehensive score of the subject. In some examples, the subject may be a group of individuals. The group of individuals may have similar characteristics (e.g., biomechanical characteristics). The system may provide the group of individuals a training program for the group. The instructions may use artificial intelligence and/or machine learning methods to efficiently intake data pertaining to the athlete and output quantifiable metrics related to biomechanical characteristics as well as other athlete wellbeing categories. In this way, the individualized training program may be objective and based on expert guidance, often rooted in scientific research and development.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The present disclosure will be better understood from reading the following description of non-limiting embodiments, with reference to the attached drawings, wherein below:

FIG. 1 shows a block diagram of a networked system for analyzing movement that provides objective outputs and individualized training programs;

FIG. 2A shows a block diagram showing inputs and outputs of the system for analyzing movement that provides objective outputs and individualized training programs;

FIG. 2B shows a process flow diagram of the system for individualized training programs;

FIG. 3 shows a flowchart of an example of a method for obtaining biomechanical scores;

FIG. 4 shows an example of an input of a biomechanical scoring module of the system for analyzing movement that provides objective outputs and individualized training programs;

FIG. 5 shows an example of biomechanical scores;

FIG. 6 shows an example of exercises of a training program organized by biomechanical score ranges;

FIG. 7 shows a flowchart of an example of a method for outputting a comprehensive score for a user.

### DETAILED DESCRIPTION

The following description relates to systems and methods and features of a testing and training system (the “system”). Overall, the system is used to identify and analyze movement patterns and anomalies in a subject or group of subjects undergoing training to produce objective outputs, each of which are analyzed, interpreted, and quantified to provide a comprehensive score for the subject or group of subjects and individualized training programs specifically designed to improve the underlying components informing the score, thereby reducing a risk of injury and improving performance.

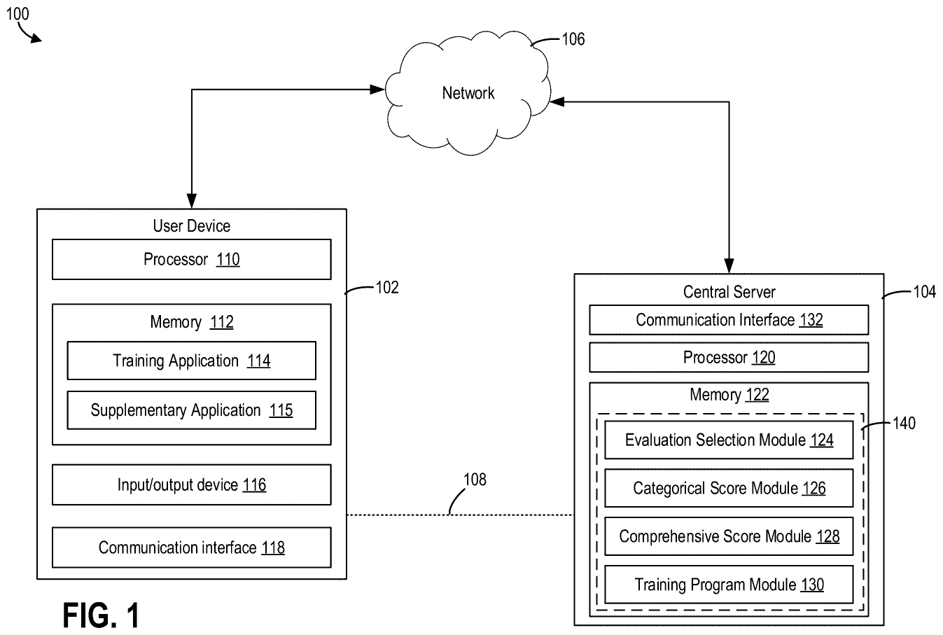

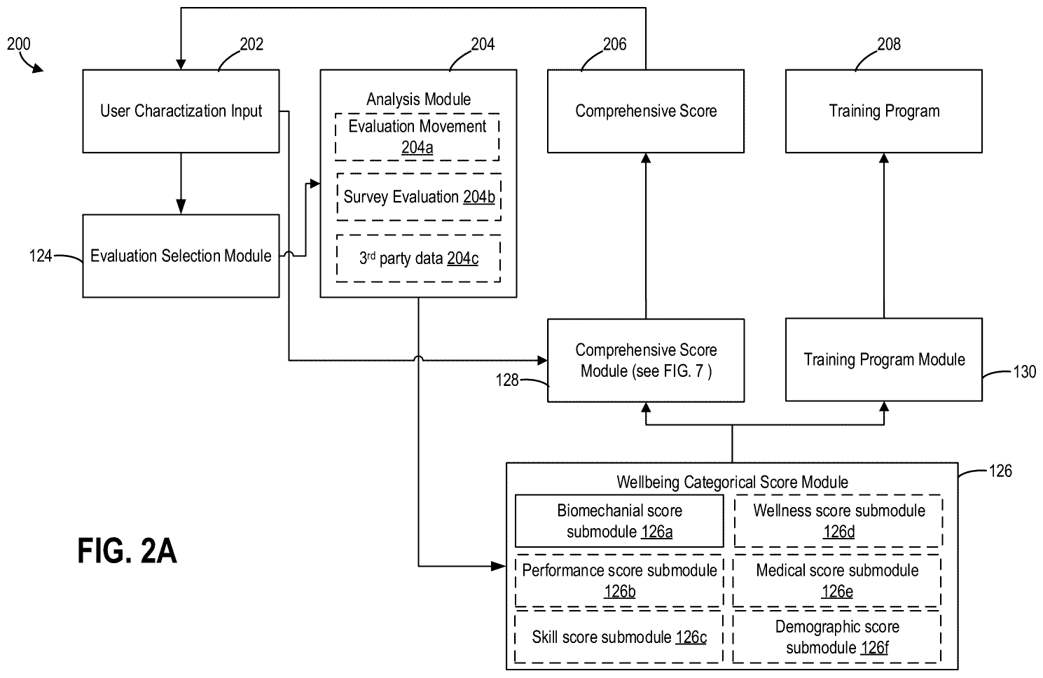

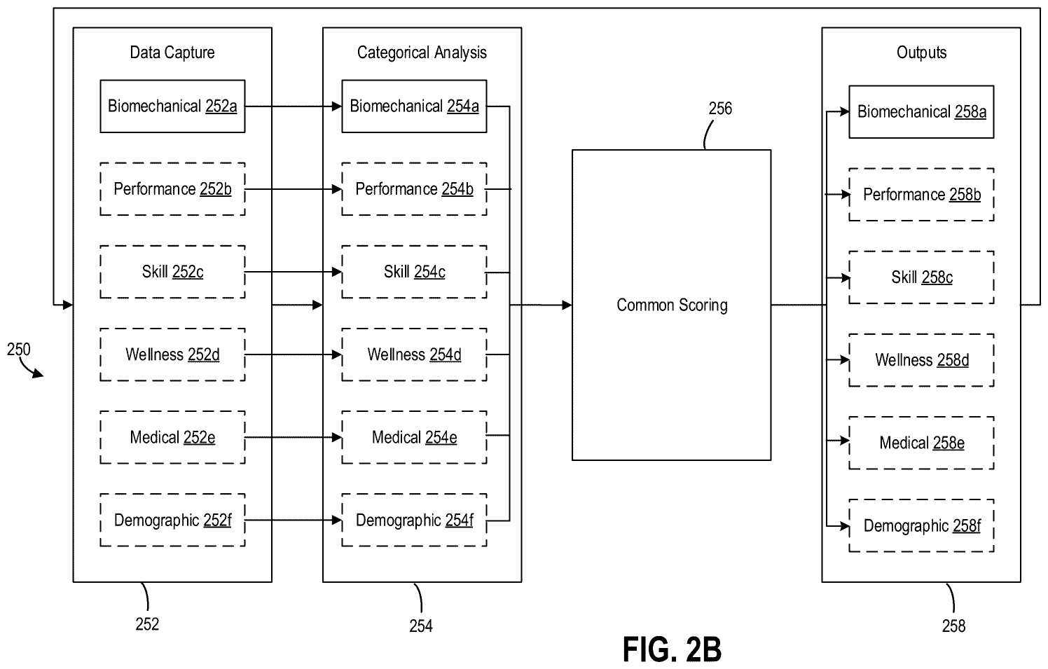

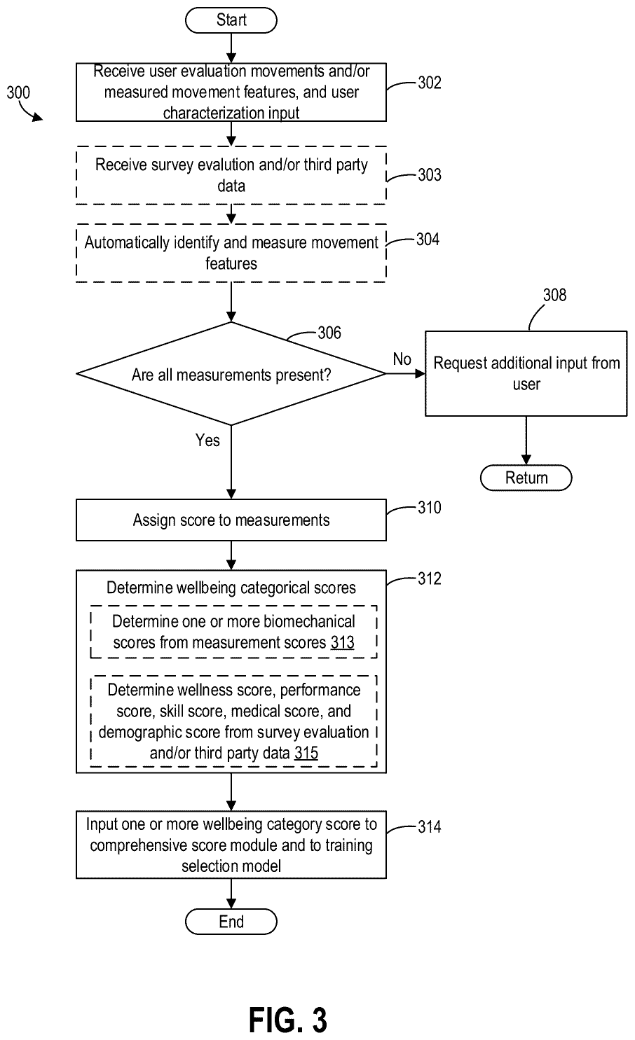

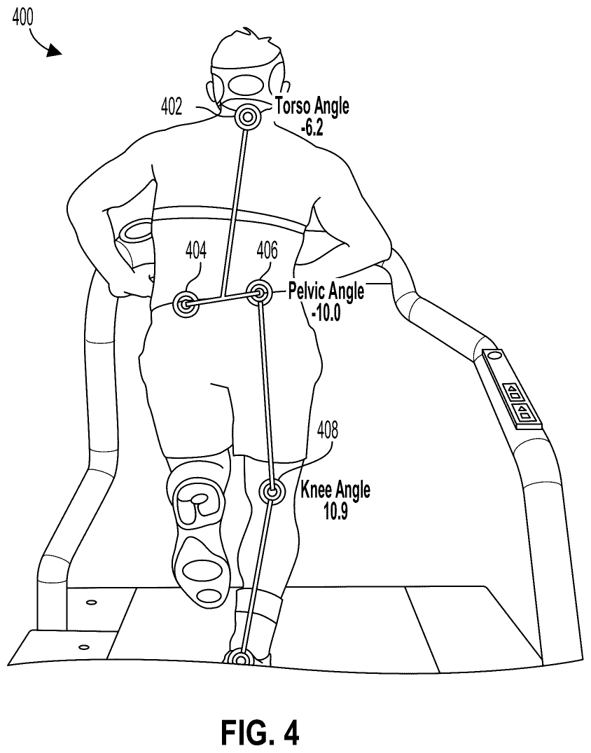

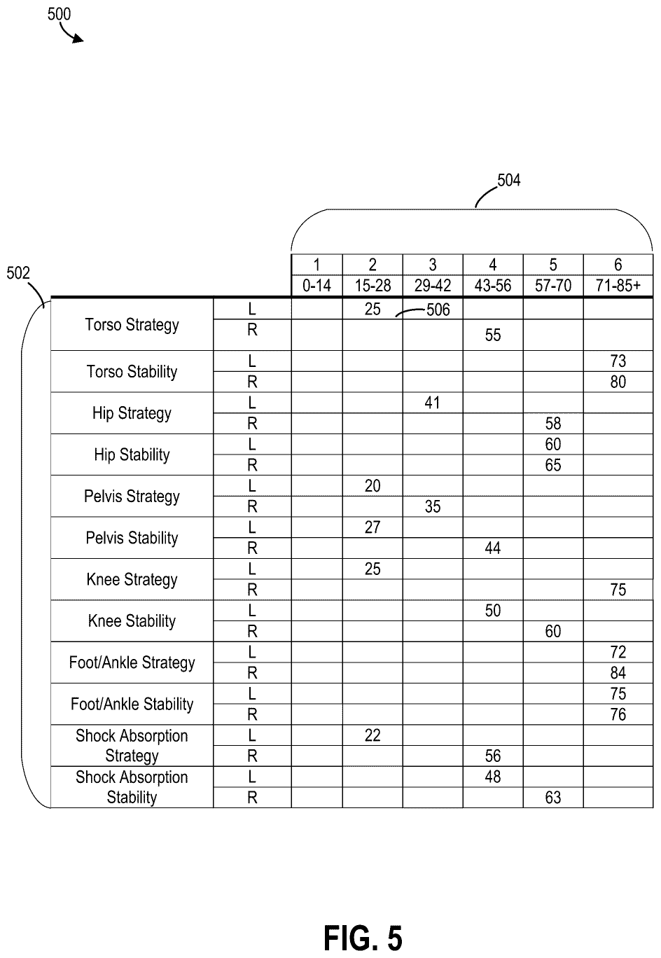

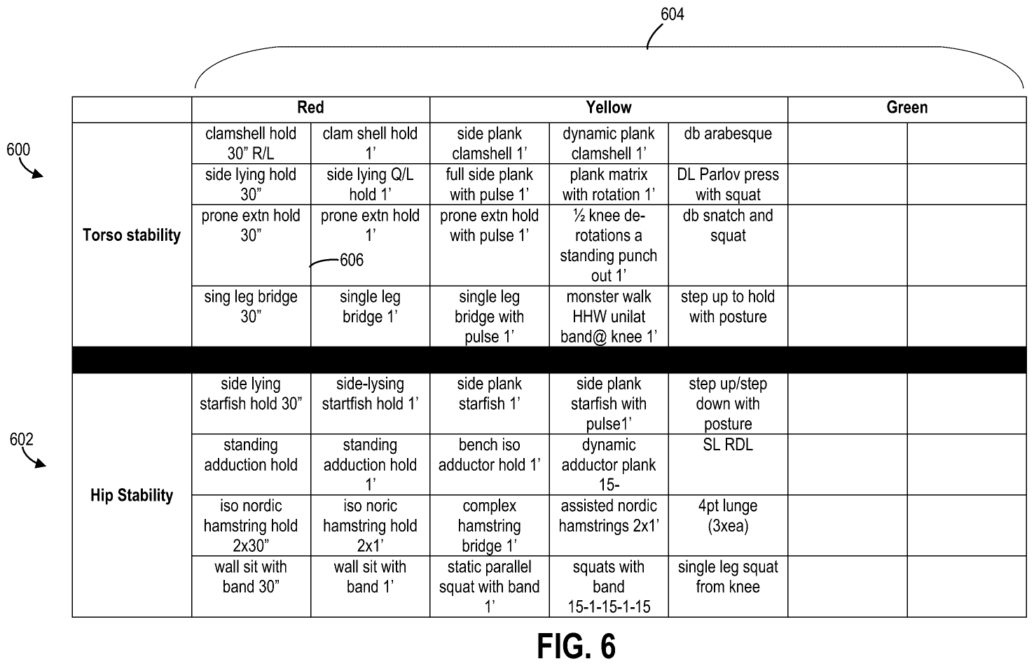

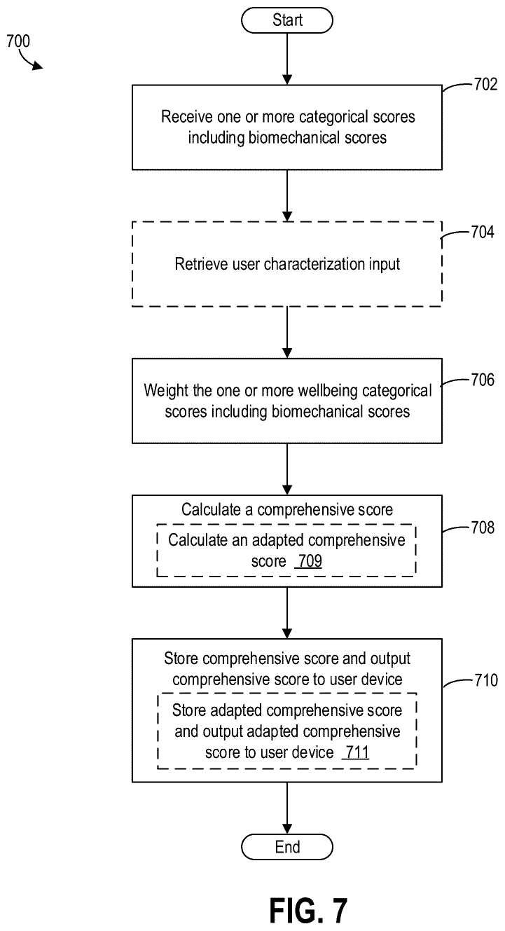

A user may interact with the system via an analysis and training application and modules of the system's application. In some examples, modules of the application may be stored at a networked device. The user device and network device are shown in a block diagram in FIG. 1. Communication between the user and modules of the system are shown in a block diagram in FIG. 2A. An example process flow of the system is shown in FIG. 2B. A user may interact with the system by capturing data that may include pictures and/or videos of a subject (e.g., athlete) performing specific exercises. Additionally or alternatively, capturing data may include receiving answers to surveys and/or biometric data, among others. In some examples, the user may be the same person as the subject. Herein, an athlete is given as an exemplary embodiment of the subject. It is understood that alternative to the subject being an athlete, the subject may be any individual or group of individuals (e.g., a team) demanding or needing analysis of their movement, a comprehensive score and one or more individualized training programs to improve a physical wellbeing. For example, the athlete may be any person having a body. Alternatively, the athlete may be a sports athlete or group of sports athletes, participating in an organized sport. Further, the athlete may be an injured subject using the system to aid in rehabilitation to return active participation in a sport, or using the system to aid in rehabilitation to return to their baseline pre-injury condition. Alternatively, the athlete may be a healthy person looking to enhance performance and proactively reduce a possibility of injury. Alternatively, the user may not be the same individual as the subject and may interact with the system's application on behalf of the athlete (e.g., the user may be a coach or trainer of the athlete). The captured pictures and/or videos and other associated data may be automatically identified and measured by the movement analysis aspect of the system as shown in FIG. 4. The segmented and measured images may be input into a biomechanical scoring module of the training system. An example of a flowchart of method for biomechanical scoring is shown in FIG. 3. An example of biomechanical scores generated by the method of FIG. 3 is shown in FIG. 5. The biomechanical scores may be used to generate the individualized training program and a comprehensive score. An example of correspondence between biomechanical scores and the individualized training program is shown in FIG. 6. An example of a flowchart of a method for outputting the comprehensive score is shown in FIG. 7.

Turning now to FIG. 1, a diagram of the training system 100 is shown. A user device 102 and a central server 104 may be communicatively connected to a network 106, such that the user device 102 may remotely communicate with central server 104. User device 102 may refer to a single user device or more than one user device 102 may be synchronized via communication with central server 104. For example, more than one user device 102 may be used at the same time and synchronized. As an alternate example, more than one user device may be used asynchronously and the data may be combined or synchronized at a later time period. In some examples, more than user device 102 may collect data at regular pre-scheduled or random times and synchronized over the multiple devices. In one example, the user device 102 may be a personal computing device, such as a mobile device, smartphone, a tablet, a laptop, etc.

The network 106 in FIG. 1 may include one or more interconnected communication networks, including for example, a cellular communication network, a local area network (LAN), a wide area network (WAN), a public network (e.g., the Internet), an enterprise private network, and/or combinations thereof. Network/communication interfaces of central server 104 and the user device 102 may employ one or more suitable communication protocols defining rules and data formats for exchanging information and communicating over the network 106, such as User Datagram Protocol/Internet Protocol (UDP/IP), and/or Transmission Control Protocol/Internet Protocol (TCP/IP). The central server 104 and user device 102 may connect to the network 106 via a hardwired link, such as an IEEE 802.3 (Ethernet) link, a wireless link using a wireless network protocol, such as 802.11 (Wi-Fi) link, and/or any other suitable link for interfacing with the network 106. In some examples, the central server 104 may connect with the user device 102 via a direct hardwired or wireless link 108.

The user device 102 may include at least one processor 110 for executing one or more instructions stored in memory 112. Memory 112 may store computer readable instructions that, when executed by processor 110, may cause components of user device 102 to perform one or more operations as will be described herein. An example of instructions stored in memory 112 includes a user training application 114 (e.g., an app).

Memory 112 may represent random access memory (RAM) comprising the main storage of a computer, as well as any supplemental levels of memory, e.g., cache memories, non-volatile or backup memories (e.g., programmable or flash memories), mass storage memory, read-only memories (ROM), etc. In addition, the memory 112 may be considered to include storage physically located elsewhere, e.g., cache memory in any computing system communicating with user device 102, as well as any storage device on any computing system in communication the user device 102 (e.g., a remote storage database, a memory device of a remote computing device, cloud storage, etc.)

The user device 102 further comprises an input/output device 116 and a communication interface 118. The input/output device 116 of user device 102 may be configured to receive data from input sources and output data to output sources, thereby serving as an interface between the input sources, the output sources, and the user device 102 may receive input data from a user input device such as a keyboard, mouse, microphone, touch screen/touch pad. In an exemplary embodiment the input/output device 116 may include one or more data collection devices. In some examples the data collection device may be a camera configured to capture photographs or movies. In some examples, the data collection device may be a wearable device, such as a smartwatch or a smart-ring, configured to collect data such as heart rate and body temperature. For example, the wearable device may be an Apple Watch® and/or an Oura® Ring. The input/output device 116 may output data to one or more user output devices such as a display, a touch screen, speakers, and/or other such output devices that may be used to output data in a format understandable to a user. As such, in some examples the processor 110 of the user device 102 may execute stored instructions using information (e.g., user input data) from the input/output device 116 based on execution of the stored instructions. It is to be understood that the user input devices and/or the user output devices may be integrated with the user device and/or may include peripheral devices communicatively connected to the computing device.

The application 114 may include code that when executed by the processor facilitates interfacing between the user device and the central server 104. For example, the user may input videos and/or pictures of an athlete performing an action captured by an input device of the user device 102. The application may process the video and/or pictures and control the communication interface 118 to transmit the videos and/or pictures to the central server 104 (e.g., via network 106).

The central server 104 may include at least one processor 120 for executing one or more instructions (e.g., stored in memory 122) to perform and/or cause components of the central server 104 to perform one or more operations. The central server 104 may further include the memory 122 and a back end 140 stored thereon to support application 114. The back end 140 stored at the central server 104 may include an evaluation selection module 124, a wellbeing categorical score module 126, comprehensive score module 128, and training program module 130. Modules 124, 126, or 128 may output potential physical risks (e.g., risk for injury) or observations of the athlete. For example, the output potential for physical risk may be output as a quantitative amount. In some examples, modules stored in memory 122 may additionally or alternatively be stored in memory 112 of the user device 102 and may be included in training application 114. The back end 140 stored on memory 122 may comprise code that when executed by the processor 120 controls the central server 104 (e.g., via communication interface 132) to receive data output from the user device 102. For example, the memory 122 includes computer readable instructions (e.g., including back end 140) that, when executed by the processor 120 may control the central server to 104 to receive the pictures and/or video transmitted by the user device 102. The central server 104 may include the communication interface 132, which may be substantially similar to communication interface 118 of the user device 102.

In some examples, central server 104 may output standardized and normalized data elements from the modules of the training application. Such elements can be ingested into a supplementary application 115 of a user device via one or more methods including from an Application Programming Interface (API) or via a flat file input. Supplementary application 115 may be an application other than training application 114 configured to receive outputs from the central server as data inputs and produce outputs which are different from and/or supplementary to outputs of training application 114.

Modules (e.g., evaluation selection module, wellbeing categorical score module, etc.) of training application 114 may be part of back end 140 and/or the training application 114 stored on the user device. Modules may include instructions to receive user input from the user device 102 and output instructions to the athlete. In some examples, one or more of the modules may be stored on the memory 112 of the user device 102 instead of or in addition to or instead of the memory 122 of the central server 104. The modules may automatically evaluate a biomechanical or other relevant performance data of the athlete and provide an individualized training program to the athlete based on the performance data. Performance related data can include items such as biomechanical, physiology, medical, wellness, and skill evaluations. The individualized training program may be specialized to performance related strengths and weaknesses of the athlete. In this way, the athlete may work on strengthening a weakness before the weakness leads to an injury. The athlete may also aim to improve and maximize athletic performance by addressing biomechanical or performance related weaknesses. Additionally, the modules output a comprehensive score that can be used to track progress of an athlete or compare different athletes.

Inputs and outputs of the modules of the application 114 are explained further below in block diagram 200 of FIG. 2A. In some embodiments the modules of application 114 may be utilized by the user on a regular basis. For example, the application 114 may automatically prompt a user for new inputs to provide a new training program and comprehensive score output at scheduled intervals. In this way, the comprehensive score and training program may adapt to changes in the subject due to the effects of the training program.

User characterization input 202 may be input to evaluation selection module 124. User characterization input 202 may be collected by an input of user device 102 through instructions included on the training application 114. As discussed above, because the application may be used multiple times, outputs from the subject's previous use or uses of the system may also be inputs to the system. The user characterization input may identify traits of the athlete for whom training application 114 may output an individualized training program. In one example, user characterization input may be a survey including questions answered by the user and/or athlete pertaining to the athlete and may be configured to characterize the athlete, including but not limited to, physical traits (e.g., sex, height, weight), injury history, and training goals (e.g., type of sport, level of competitiveness). Based on the received user characterization input 202, evaluation selection module 124 may determine data to be collected by analysis module 204. Analysis module 204 may include instructions to capture or otherwise ingest information about the subject, used as raw data inputs. Analysis module 204 may selectively request data from the user based on the user characterization input 202 and evaluation selection module 124 to minimize an amount of processing power and memory demanded by analysis module 204.

Analysis module may ingest evaluation movements 204a. Analysis module 204 may output to a display of the user device 102 a list of evaluation movements 204a. The list of evaluation movements may include a movement (e.g., squat, run, toe touch, etc.) and an angle at which to capture the evaluation movement (e.g., front, rear, left or right side). In some examples, the list of evaluation movements may include a speed/intensity for the athlete to perform the movement (e.g., slow or explosive). Further, the tests may be directed toward one or more types of movements. In some examples, the tests may be directed to a specific athlete based on their sport or other characteristics. For example, the tests may include or more of, but not limited to, static tests, slow tests, fast tests, and ballistic tests. In some examples, the list of evaluation movements may include capturing the same movement at multiple angles. In one example, the list of evaluation movements may be generated by a rules based system based on the user characterization input. The evaluation movements 204a may be captured by a native camera of the user device (e.g., user device 102). In further examples, multiple cameras may be used to capture the evaluation movements 204a.

As one example, the user evaluation movement may be a squat and counter movement jump. The squat and counter movement jump may be captured from a side view (e.g., in profile) and a front view. In the side view of the subject in a squat position angles and lengths may be determined (e.g., measured from the data captured by the data collection device). For example, an angle between the subject's knee, toe, and ground may be determined. Additionally or alternatively, an angle between the subject's head, toe and ground may be determined. Further an angle between the subject's knee, ankle and a line perpendicular to the ground may be determined. In a front view, a deviation of a line drawn through a center of the subject's torso from perpendicular to the ground may be determined. Further, a deviation of the subject's hips from parallel to the ground may be determined. Further, an angle between the subject's hip, knee, and foot may be determined for both a right and left side.

As another example, the user evaluation may additionally or alternatively include a triple hop. The triple hop may be captured from a side view and front view. In a front view, the subject may be captured landing on one foot. An angle between the subject's hip, knee and foot may be determined for the landing leg. Additionally or alternatively, the same image may be used to determine a deviation of a line drawn from through the subject's torso from a line perpendicular to the ground. Additionally, a deviation of a line drawn between the subject's hips from a line parallel to the ground may also be determined. In a side view, an angle between the subject's head, toe, and ground may be determined. Additionally or alternatively, an angle between the subject's knee, toe, and ground may be determined. In further examples, an angle between the subject's ankle, knee, and toe may be determined. In further examples, an angle between the subject's head, hip, and mid-back may be determined.

As a further example, the user evaluation may additionally or alternatively include a step down. The step down may be captured from a front and side view. In a step down, the subject may be captured with one foot on the step (e.g., the step foot) and the other foot extended forward in front of the step. In the front view, an angle between the subject's hip, knee and step foot may be determined. Further a deviation of a line through the subject's torso from perpendicular to the ground may be determined as well as a deviation of a line between the subject's hips from parallel to the ground. The side view may be captured with a subject's step foot resting closest to the camera or other data collection device. An angle between the subject's head, toe of the step foot, and a line parallel to the ground may be determined. Additionally or alternatively, an angle between the subject's knee, toe of the step foot and a line parallel to the ground may be determined. Further, an angle between the subject's head, hip, and mid-back may be determined.

As a further example, the user evaluation may additionally or alternatively include running. In some examples, the subject may be recorded while running on a treadmill. For example, the subject may be captured from a side view, front view, and rear view while running. Further, angles and distances of the subject may be determined over various points of a running stride. For example, the subject may be captured during initial contact, midstance, and terminal stance.

As one example, initial contact may be captured in the side view and the rear view. In the side view, an angle between the subject's head, hip, and a line perpendicular to the ground (or the treadmill surface) may be determined. Further, an angle between the subject's hip, ankle, and the line perpendicular to the ground may be determined. Additionally or alternatively, in the rear view of initial contact, an angle between a toe of the lifted running foot, the ground and a line perpendicular to the ground. Further an angle between the subject's head, a midpoint of the hips and a line perpendicular to the ground may be determined. In further examples, a deviation of a line between the subject's hip and a line parallel to the ground may be determined.

As a further example, midstance of running may be captured in a side view and rear view. In a side view, an angle between the middle of the subject's planted foot, the hip and a parallel to the ground may be determined. Additionally or alternatively, an angle between the subject's hip, head and a line perpendicular to the ground may be determined. Further, an angle between the subject's knee (of the leg with the planted foot), the toe of the planted foot and a line parallel with the ground may be determined. Still further, an angle between the subject's hip, knee, and point in front of a toe of the planted foot may be determined in addition to an angle between the ankle of the planted foot, the knee, and the point in front of the toe may be determined. In the rear view, an angle between the subject's head, mid-point of the hips and a line perpendicular to the ground may be determined. In further examples, a deviation of a line between the subject's hip and a line parallel to the ground may be determined. Additionally or alternatively, on the side of the subject corresponding to the planted foot, an angle between the hip, knee and ankle may be determined.

As a further example, the terminal stance of running may be captured in a side view. In the side view, an angle between the subject's knee, hip and a line perpendicular to the ground for the side of the subject corresponding to the planted foot may be determined.

Additionally or alternatively, a posture of the subject may be recorded. Posture may be recorded in one or more of a front facing image, a rear facing image, and a profile image. In the rear facing image, a torso stability and foot/ankle stability may be determined. For example, torso stability may be at least partially determined from an angle between a middle of the subject's neck, a midpoint of the hips and a point between the neck and shoulder of the subject. Further, torso stability may be determined at least partially by a deviation from a line between the subject's hips and a line parallel to the ground. Foot/ankle stability may be at least partially determined by an angle between the ankle, heel of the foot, and a line perpendicular to the ground. Additionally or alternatively, in a front facing image an angle on each side between the hip, knee and ankle may be determined and may be used to determine hip stability. Further in the profile image, an angle between a top of the chest, hip, and a line perpendicular to the ground may be determined and may be used to calculate a torso strategy.

As a further example, user evaluation movements may additionally or alternatively include a hamstring straight leg raise. The hamstring raise may include the subject lying supine on a surface and lifting a straight leg upwards while the other leg remains flat on the surface. The hamstring leg raise may be recorded in a side view. The side view may be captured with the raised leg closest to the camera or other data collection device. The side view may be used to determine an angle between an ankle of the raised leg, a hip of the raised leg and a line parallel to the ground (e.g., surface the subject is lying on).

In some examples, user evaluation movements may be targeted towards a specific muscle. For example, a user evaluation movement may target a knee muscle such as the popliteus muscle. To evaluate the popliteus muscle the subject may lie supine and flex a leg to bring the knee to be analyzed to the chest while the other leg remains flat. An angle between the subject's hip, knee, and angle of the flexed leg may be determined in a side view with the flexed leg closest to the camera or other data collection device.

In some examples, user evaluation movements may include stretches. For example, a Thomas stretch may be recorded in a side view. In a Thomas stretch, the subject may lie supine on a surface with a planted leg extending off an edge of the surface and an opposite leg flexed in towards the chest. The camera or other data collection device may record the Thomas stretch in a side view with the planted leg closest to the camera. An angle between the subject's hip, knee, and a line parallel with the surface may be determined for the planted leg.

In further examples, user evaluation movements may include poses to determine stability and/or strategy related to a foot and/or ankle. For example, an ankle may be based on capturing the subject in a side view with feet staggered forward and backward. The subject may bend knees forward and may use a table for balance. For the foot closest to the camera or other data capture device, an angle between the toe, ankle, and knee may be determined. Additionally or alternatively, the subject may be captured in a side view standing on one foot with the planted foot closest to the camera. In the same side view, the subject may be captured with the knee of the planted leg bent. An angle between the toes, ankle, and knee of the planted foot may be determined for both the straight and bent images.

Analysis module may also ingest input in the form of a survey evaluation 204b of the athlete (e.g., subject). Survey evaluation 204b may be generated at the user device by evaluation selection module 124. As one example, the survey evaluation may include multiple choice or numerical questions chosen to assess factors relevant to the inputs into the application and system. For example, survey evaluation 204b may include questions directed to general wellness of the athlete. As another example, survey evaluation 204b may include questions directed to clinical aspects of the athlete's history. As another example, survey questions may be asked as to whether the athlete is in a “healthy” or rehabilitating state, the latter inclusive of injury recovery. The myriad survey questions that may be administered may also yield a different comprehensive biomechanical score and a different set of individualized training programs.

Analysis module may also ingest third party data 204c. Third party data may be requested by evaluation selection module 124. For example, third party data may include data captured by movement analysis hardware. Movement analysis hardware may include, for example, motion capture cameras or force plates. Further, third party data may include other surveys or data logs collected by and stored in third party software. As a further example, third party data may include data captured by wearables such as a device configured to capture real time heart rate and body temperature of the subject while performing the evaluation movements and/or while resting.

The user may capture the athlete performing the evaluations movements using a data collection device coupled to one or more user devices 102. In some examples, the data collection device may be a camera or a plurality of cameras. In some examples, the data collection device may be a motion capture system and/or computer vision system. In some examples, the data collection device may be communicatively coupled and physically coupled to one or more user devices 102. In alternate examples the data collection device may be communicatively coupled and not physically coupled to the one or more user devices 102. For example, the data collection device may be a motion capture system remote from user device 102 and motion capture data (e.g., images, angles, forces, among others) may be received by the one or more user devices 102. In some examples, measurement of user evaluation movements (as described further below) may be performed on the data collection device and received by user device 102.

In an exemplary embodiment, the camera input may be a native camera of the user device 102. In further examples, the evaluation movements may be captured by more than one camera. For example, where user device 102 is a smartphone or tablet, the camera input is a native camera of the smartphone or tablet. The camera may capture multiple still photos or a video. In examples where a video or other active motion capture is used, a frame rate equal to or greater than a minimum threshold framerate may be demanded for reliable and reproducible analysis. The minimum threshold frame rate may decrease as algorithms for analyzing the motion capture information are better trained (e.g., AI algorithms) and/or more complex. As one example, the minimum threshold framerate may be 100 frames per second (fps). In alternate examples, the minimum threshold framerate may be 120 fps, or may be 150 fps, or may be in a range of from 100 fps to 150 fps. In some examples capturing the athlete performing the evaluations may be done without additional sensors worn by the athlete during the movement. The video/pictures of the athlete performing the evaluation movements may comprise the evaluation movements 204a which may be input to a wellbeing categorical score module 126.

The wellbeing categorical score module 126 may include one or more submodules each submodule directed to scoring categories targeted to different aspects of performance readiness. The wellbeing categorical score module may include a collection of scores that are directed to different aspects of the overall wellbeing of the subject. Taken together, these aspects may encompass a holistic snapshot of the ability of the subject to perform as an athlete. For example, the wellbeing categorical scores may reflect, physical, mental, and environmental aspects of overall wellbeing. For example, wellbeing categorical score module 126 may include biomechanical score submodule 126a and optionally include one or more of performance score submodule 126b, skill score submodule 126c, wellness score submodule 126d, medical score submodule 126e, and demographic score submodule 126f.

The wellbeing categorical score module may translate data from the different sources of the analysis module into a common format that can be used to calculate the wellbeing categorical scores. For example, the wellbeing categorical score module may translate movement data from a video, survey data, and heart rate data from a wearable into a common framework in order to calculate one or more wellbeing categorical scores. Translating the data may include sorting and classifying the data to fit the data into a common framework.

Biomechanical score submodule 126a may include instructions to identify and measure the evaluation movements 204a. Based on identification and measurements, the biomechanical score submodule 126a may determine biomechanical scores for a plurality of biomechanical traits of the athlete. The biomechanical score submodule 126a may also output potential physical risks or observations of the athlete. The instructions of the biomechanical score submodule 126a are discussed further below with respect to FIG. 3. The biomechanical scores output by biomechanical score module 126a may be input to the comprehensive score module 128 and the training program module 130.

Performance score submodule 126b, skill score submodule 126c, wellness score submodule 126d, medical score submodule 126e, and demographic score submodule 126f may include instructions to calculate scores based on one or more of survey evaluation 204b and third party data 204c.

Comprehensive score module 128 may include instructions to assign a single comprehensive score to the athlete based on the plurality of wellbeing categorical scores. Additionally or alternatively, the comprehensive score may be based on a characterization of the user. In some examples, comprehensive score module 128 may include instructions to output a comprehensive score based on wellbeing categorical scores and an adapted comprehensive score based on both user characterization and the categorical scores. The comprehensive scores may be output by comprehensive score module 128 to a display of the user device (e.g. an input/output of the user device). The comprehensive score may enable a normative view of multiple athletes. The comprehensive score may encompass a relative ability of the athlete to perform competitively. As one example the comprehensive score may be used to determine the relative ability of the athlete when compared to a second athlete having similar user characteristics to the athlete. In one example, the comprehensive score may be assigned on a scale of possible comprehensive scores (e.g., on a scale of 0-100). The instructions of the comprehensive score module 128 are discussed further below with respect to FIG. 7.

Training program module 130 may include instructions to output a training program 208 (e.g., an individualized training program) based on the plurality of wellbeing categorical scores. In some examples, the training program may include one or more training programs, each of the one or more training programs corresponding to a submodule of the wellbeing categorical score module. The training program module 130 may output the training program to a display of the user device. In one example, the training program module 130 may include rules-based instructions, assigning training exercises corresponding to movements chosen to increase each of the biomechanical scores. In some examples, the user may select the training program volume and frequency.

In some examples, the training program modules may include a machine learning algorithm. The machine learning model may be configured to receive wellbeing categorical scores and output training programs. As one example, the machine learning algorithm of the training program module 130 may be trained by examples of training programs and corresponding biomechanical and/or other wellbeing categorical scores determined for an athlete before and after completing a training program. In such an example, the machine learning model may be trained to output training scores to increase wellbeing categorical scores using a training program as input data and difference in wellbeing categorical scores for the subject before and after completing the training program as ground truth data. In this way the machine learning algorithm may learn which training programs result in measured increases in wellbeing categorical scores.

The user/athlete may receive the comprehensive score 206 and the training program 208 at a display of the user device 102. After following the training program 208, the athlete repeats training application 114 as shown in block diagram 200 and begins by inputting user characterization input 202. User characterization 202 may include whether or not the athlete has already followed an individualized training program and for how long. Additionally, the user characterization 202 may include a previous comprehensive score. In some examples, a returning athlete may manually enter a previous comprehensive score and information regarding a previous individualized training program as part of user characterization input. In further examples, the system may store a previous comprehensive score and individualized training program of an athlete and automatically include the stored information as part of user characterization 202. In this way the athlete may receive an updated individualized training program and comprehensive scores 206 may track progress of the athlete.

A process flow 250 of the system is shown in FIG. 2B. A data capture 252 of the process flow may include separate data capture for a plurality of categories. Data capture 252 may incorporate the analysis module 204 as described above with respect to FIG. 2A. Data capture 252 may be segmented by category of the training system. For example, the data capture may include a biomechanical category 252a. Data capture related to the biomechanical category 252a may include one or more of motion capture, third party data, and survey inputs. Additionally, categories may optionally include performance 252b, skill 252c, wellness 252d, medical 252e, and demographic 252f. Data capture for optional categories may further include survey data, third party data, or other types of test results uploaded to or recorded by the system.

Inputs of the data capture 252 may be fed into categorical analysis 254. Categorical analysis 254 may incorporate wellbeing categorical score module 126 as described above with respect to FIGS. 1 and 2A. Categorical analysis 254 may include the same categories as data capture 252. Categorical analysis 254 and data capture 252 may correspond in a one-to-one fashion. For example, each data capture category may feed data into a corresponding categorical analysis category. Further each categorical analysis category may perform analysis of each input associated with the corresponding data capture category. Categorical analysis in this way streamline coding of the system and customization of the system based on categories of relevance to the user.

Categorical analysis 254 may include a biomechanical category 254a. Biomechanical feature 254a may be configured to receive and analyze data of the biomechanical category 254a of data capture 252. Categorical analysis of biomechanical category 254a may include analysis of angles and ratios measured from the data capture features to determine, for example, flexibility, strength, and mobility. Analysis performed by biomechanical analysis category 254a may be described further below with respect to FIG. 3. In some examples, categorical analysis of biomechanical feature 254a may further include analysis of forces or other biomechanical movements. Categorical analysis 254 may optionally include additional categories including performance category 254b, skill category 254c, wellness category 254d, medical category 254e, and demographic category 254f.

Analysis performed by categorical analysis 254 may be fed into common scoring 256. Common scoring 256 may include comprehensive score module 128 as described above with respect to FIGS. 1 and 2A. Analysis from each category of categorical analysis 254 may be combined within common scoring 256. In some examples, the common scoring 256 may include modifiers. For example, the modifiers may be specific to a known sport or combination of sports in which the subject is training. The common scoring 256 may include test scores, where each test score may correspond to a data capture 252. Each data capture 252 and corresponding analysis 254 may result in a corresponding test score. The test scores may be used to calculate one or more wellbeing categorical scores. For example, the test scores may be combined or directly correspond to an output 258. Wellbeing categorical scores may be calculated for each of the categories described above. Wellbeing categorical score may include a biomechanical score as described further below. The one or more wellbeing categorical scores may be combined within common scoring 256 to result in comprehensive score.

Common scoring 256 may be used to generate outputs 258. Outputs 258 may include training programs such as training programs output by training program module 130 as described above with respect to FIGS. 1 and 2A. Training programs may include a selection of activities curated based on the scores (e.g., test, categorical, and comprehensive) output by common scoring 256. As one example, the activities may include physical activities. Physical activities may include movements, such as exercises, to be repeated a number of times for a set time duration. As another example, the activities may include mental activities such as meditation. In further examples, the activities may include recovery activities such as massage.

Outputs 258 may include an output (e.g., training program) corresponding to each category included in data capture and categorical analysis. For example, outputs may include a biomechanical output 258a. Biomechanical output 258a may be an exercise training program. Additionally, outputs 258 may optionally include programs for performance 258b, skill 258c, wellness 258d, medical 258e, and demographic 258f. In some examples, outputs 258 may be prioritized. Prioritization may be customized to the subject based on the data capture, analysis, and common scoring. Prioritization may rank and/or weight the output training programs in an order of importance. The highest priority training programs may be programs predicted by the system to have the highest improvement of the comprehensive score. Additionally or alternatively, prioritization may rank the training programs in an order to be completed. The order of training programs may be provided in order to have the highest improvement on the comprehensive score. In some examples, prioritization may be modified by an input of the user. For example, the user may input an amount of time available for training over a given time interval (e.g., a week) and the training programs may be prioritized accordingly. As another example, the prioritization may be weighted based on daily input from the subject. For example, in response to the subject feeling on a training day a wellness output 258d may be ranked a first priority for the day.

The process flow 250 may be repeated multiple times for the same subject. In some examples process flow 250 may be repeated at regular intervals. For each repetition, new data may be captured from the subject and fed into categorical analysis resulting in new common scoring and outputs. In some examples, priorities of the outputs may also change upon retesting. Further, retesting a subject may be used to train a machine learning algorithm configured to generate training program outputs and weights for calculating a comprehensive score. For example, a training program may be a training input and changes in the wellbeing categorical scores measured upon retesting after the training program may be a ground truth. In this way the machine learning model may learn training program elements which result in increased scores.

Turning now to FIG. 3, a method 300 for outputting one or more wellbeing categorical scores based on evaluation movements (e.g., evaluation movements 204a of FIG. 2A) and other data ingested by an analysis module of the system is shown. The one or more wellbeing categorical scores may correspond to the wellbeing categorical score submodules described above with respect to FIG. 2A. The method 300, as well as method 700 described further below, may be implemented as part of the system, such as the system 100 of FIG. 1. Instructions for carrying out the methods 300 and 700 may be executed by processors of a central server and a user device, such as processor 120 and processor 110 of FIG. 1, based on instructions stored on non-volatile memory of each of the central server and the user device.

The method 300 may, in one example, be initiated by a user inputting video and/or pictures of an athlete performing evaluation movements that have been chosen by an evaluation selection module, such as evaluation selection module 124. At 302, method 300 includes receiving user evaluation movements and/or measured movement features, and a user characterization. The user evaluation movements and/or measured movement features may be received from a data collection device such as the data collection device described above. In some examples, the user evaluation movements may include a video or pictures of the athlete performing the evaluation movements. In some examples, the user evaluation movements may be data inputs received from other data and/or movement capture systems which capture movements or data related to movements of the subject (e.g., the athlete). The captured user evaluation movements are stored on a memory of the user device and communicated to the central server by a communication interface. In further examples, the measured movement features may be received from the data collection device. The measured movement features may include lengths and angles related to the user evaluation movements as described further below with respect to step 304. In some examples, receiving user evaluation movements may also include receiving responses to survey evaluation questions. At 303, method 300 optionally includes receiving survey evaluation data and/or third party data. Survey evaluations may be survey evaluation 204b of FIG. 2A and third party data may be third party data 204c of FIG. 2A.

At 304, method 300 optionally includes automatically identifying and measuring movement features. Automatically identifying and measuring movement features may be triggered upon receiving user evaluation movements without any prompting from the user or any input from a skilled technician. As one example, automatically identifying and measuring movement features may be performed by an image processing algorithm. Identification may include identifying an anatomical feature (an/or multiple anatomical features) of the athlete present in an image, such as a head, pelvis, shin, heel, etc. Measuring may include mathematical calculations determining distances and angles or other measurements and calculations between the identified features. Automatically identifying and measurement movement features may be performed to generate measured movement features not received from the data collection device at 302.

Turning briefly to FIG. 4, an example of an image 400 including identified anatomical features used for measurements is shown. Image 400 may be a picture captured by a camera of the user and/or a still picture isolated from a video captured by the camera of the user. Image 400 includes annotations corresponding to anatomical features which may be identified at step 304 of method 300. For example, top torso point 402, left pelvis point 404, right pelvis point 406, and a right knee 408 may be identified. Distances and angles between the identified anatomical features may, for example, include a pelvic angle, torso angle, and knee angle. In some examples, measuring movement features may include, in addition to static lengths and angles, automatically measuring a range of angles and lengths recorded in the evaluation movements. In further examples, measuring movement features may include automatically measuring rates of change of angles and lengths recorded in the evaluation movements.

Returning now to FIG. 3, at 306, method 300 determines if all of the measurements are present. Method 300 may be configured to receive specific anatomical features and corresponding measurements based on the evaluation movements requested by the training application. Method 300 may not demand all of the user evaluation movement inputs from an initial test or assessment to complete a retest. Said another way, first user evaluation movement inputs for a subject first receiving biomechanical scores, comprehensive scores, and a training program may include more inputs than user evaluation movement inputs when the same subject is retested to determine updated biomechanical scores, comprehensive scores and a training program. Determining if all the measurements present may include comparing the corresponding measurements with those identified from the received inputs. If all demanded measurements for a test or a retest are not present (NO), method 300 proceeds to 308 and includes requesting additional input from the user. Requesting additional input may include requesting the user submit pictures/videos of evaluation movements corresponding to missing measurements. Method 300 returns.

If all demanded measurements are present (YES), method 300 proceeds to 310. At 310, method 300 includes automatically assigning a score to each of a plurality of the measured movement features. Step 310 in addition to steps 312 and 214 described further below may be performed by a common scoring function of the system, such as common scoring 256 shown in FIG. 2B. Automatically assigning scores may occur directly following the determination that all measurements are present without any input by a skilled professional. Assigned scores may be unitless values assigned to each movement measurement. As one example, assigning scores may include inputting measured movement features to a rules-based algorithm including instructions to assign a score based on the measurements output at step 304. In some examples, user characterization information, such as user characterization 202 of FIG. 2A, including physical traits may be input to the rules based algorithm in addition to the measurements to assign the score. For example, some scoring may take into account gender or specific sport variables. In further examples, the assigned scores may also be based on the inputs provided by the user in response to the survey evaluation. By automatically scoring movements in this way, quantitative information regarding the subject's physical performance may be determined using basic camera inputs and optionally survey evaluation and third party inputs. By using the basic camera, survey inputs, and third party data, automatically assigning scores is a computationally efficient process.

In some examples, assigning scores may include inputting the measurements and optionally the survey responses into a machine learning algorithm. The machine learning algorithm for assigning scores may be trained based on pairs of user movement inputs and assigned scores. In this way, the machine learning algorithm may automatically output assigned scores from evaluation movements without first identifying and measuring. In this way the machine learning algorithm for assigning scores may increase a computational efficiency of method 300.

At 312, method 300 includes automatically determining one or more wellbeing categorical scores. The one or more wellbeing categorical scores may be determined automatically following assigning the measurement scores with no additional input from a skilled professional. The one or more wellbeing categorical scores may be determined using a common scoring applied to a set of analyzed data associated with each of scores of the wellbeing categorical scores as discussed above with respect to FIGS. 2A-2B. Each of the one or more wellbeing categorical scores may be based on one or more individual test scores associated with the category.

At 313, automatically determining one or more wellbeing categorical scores includes determining one or more biomechanical scores from the assigned scores output at step 310. In some examples, the biomechanical scores may be determined from an algorithm. In some examples the algorithm may use machine learning models.

As one example, the biomechanical scores may be determined using an algorithm configured to compare one or more measurement scores assigned at step 310 to ideal measurement scores. For example, the measurements taken during a user evaluation may yield measurement scores that may provide one or more inputs into a torso strategy, that is compared against the measurement scores that result in an ideal torso strategy. In some examples, the ideal measurement scores may be selected depending on the user characterization. Each biomechanical score may correspond to an aspect of the athlete's movement that may be addressed by the individualized training program. Measurements and biomechanical scores may not correspond in a one to one fashion. In one example a rules based algorithm may be used to determine one or more biomechanical scores from the measurement scores. The rules based algorithm may use more than one measurement score to calculate a single biomechanical score. Additionally or alternatively, the rules based algorithm may use a single measurement score in determining more than one biomechanical score. Similar algorithms which compare ideal results to the results analyzed from the inputs of the athlete may be used for other scores of the wellbeing categorical scores.

In some examples, a machine learning algorithm (e.g., in addition to or alternative to artificial intelligence) may be used to determine one or more biomechanical scores from the assigned measurements. In one example, the machine learning algorithm may be trained using a paired set of measurements and biomechanical scores determined by the rules based algorithm. In alternate examples, an artificial intelligence and/or machine learning may be trained to assign biomechanical scores based on evaluation movement inputs by an expert user determining biomechanical scores from evaluation movement inputs. In some examples the machine learning algorithm may output one or more biomechanical scores from the received evaluation movements.

At 315, automatically determining one or more wellbeing categorical scores optionally includes determining a wellness score, performance score, skill score, medical score, and demographic score from one or more of the survey evaluation and third party data. In some examples, an algorithm may be configured to analyze the survey and/or third party data to automatically generate each score. In some examples, the algorithm configured to analyze the survey and/or third party data may be an artificial intelligence and/or machine learning algorithm.

Turning briefly to FIG. 5, a table 500 including biomechanical scores is shown. Table 500 shows an exemplary embodiment of biomechanical scores, different quantities and types of biomechanical scores are also considered within a score the application. Table 500 includes rows 502, each row corresponding to a biomechanical score. In an exemplary, non-limiting embodiment, the biomechanical scores may correspond to six different features: torso, hip, pelvis, knee, foot, and shock absorption. These six exemplary features may be determined to encompass features of an athlete which may be used to generate both an individualized training program and a comprehensive score of an athlete's performance. By identifying the six features for measurement scores and comparative ideal scores, an amount of information demanded to output an individualized training program and a comprehensive score may be determined by a survey and a conventional camera (e.g., native smartphone camera) without demanding specialized equipment or expert evaluation of each captured movement. The six exemplary features may encompass an overall performance level of the athlete. In some examples a biomechanical score may include a left score based on the left side of the athlete and a right score based on the right side of the athlete. The left score and the right score of a biomechanical score may be the same value or different values. In further examples, anatomical features (e.g., the six exemplary features) may be scored for both strategy and stability. The strategy score may be identified in a sagittal plane and corresponds to integration of torso, pelvis, femur, knee joint, foot/ankle complex; evaluation of how the athlete plans, sequences and synergizes movement to enhance movement economy, attenuate shock and optimize load on the body. The stability may be identified in the coronal plane, and corresponds to the capability of the torso, pelvis, femur, knee joint and foot/ankle complex to synergistically provide stabilization support and balance during static and dynamic tasks. Taken together, strategies and stabilities provide a comprehensive view towards the human body's ability to move in a healthy fashion with mechanical efficiency. Columns 504 of table 500 may correspond to sub-ranges of different biomechanical scores. As one example, the biomechanical scores may be in a range between 0 and 100 and may be divided into multiple different sub-ranges. Other ranges of biomechanical scores and divisions of sub-ranges are considered within a scope of the disclosure. For each row 502, a biomechanical score is indicated in table 500. For example, score 506 is filled in as 25 corresponding to a biomechanical score related to torso strategy on the left side. The score of 25 may be calculated using a combination of more than one measurement score compared to the combination of measurement score corresponding to an ideal torso strategy on the left side for a similar athlete.

Returning now to FIG. 3, at 314, method 300 includes inputting the one or more wellbeing categorical scores to a comprehensive score module (e.g., comprehensive score module 128) and to a training program module (e.g., training program module 130). The one or more wellbeing categorical scores may include the biomechanical score. In this way, movements of the athlete may be translated into scores which are indicative of the athlete's strengths, weaknesses and/or movement inefficiencies, and the scores may be used to output an individualized training program. The additional wellbeing categorical scores (e.g., functional score, skill score, etc.) may also further contribute to the comprehensive score and may also each result in a respective training program. The biomechanical score and other wellbeing categorical scores alone may not be used as actionable data. Instead, as described further below, the biomechanical scores may be used to determine a training program and comprehensive score, both of which provide a course of action for athletic training. Method 300 ends.

Turning now to FIG. 6, an exemplary embodiment of an individualized training program output by the training program module based on biomechanical scores is shown. In the example, a first table 600 and second table 602 showing rules for outputting a training program based on biomechanical scores is shown. First table 600 and second table 602 may each correspond to a left/right pair of biomechanical scores. First table 600 and second table 602 each include columns 604 corresponding to each sub-range of biomechanical scores. A cell of first table 600, such as cell 606 may include an exercise that is included in a training program for an athlete that has a biomechanical score corresponding to the first table in the sub-range according to the column. In some examples, the left score and right score pair of biomechanical scores may be averaged to obtain a combined left/right biomechanical score corresponding to a table such as first table 600 or second table 602.

As one example, tables such as first table 600 and second table 602 may be included in an individualized training program module. In some examples, different tables may be included for a single biomechanical score and may be referred to according to other athlete characteristics (e.g., sex, age, sport, etc.). As a further example, the individualized training program as described in relation to this example and the other examples of this disclosure may include progressions. For example, the individualized training program may include a first exercise performed for a number of repetitions at a first intensity for a first duration and after the first duration, increase the number of repetitions and/or intensity of the first exercise. In some embodiments, after the first duration, the second exercise may be added to the individualized training program. In some examples, the progressions may be included in a first individualized training program. Additionally or alternatively, the progression may be added after the athlete is retested and a second individualized training program is provided.

In some examples, the individualized training program may be a training program provided for a team of individuals. An individualized training program for a team may divide members of the teams into subgroups based on similar biomechanical scores and/or other wellbeing categorical scores. A different training program may be generated for each subgroup of the team.

In further examples, a machine learning algorithm (e.g., in addition to or alternative to artificial intelligence algorithm) may be included in the training program module. The machine learning algorithm may be configured to output a training program based on inputs of biomechanical scores and other athlete characteristics. The machine learning algorithm may be trained using rules based tables such as first table 600 and second table 602 of FIG. 6. In some examples, the machine learning algorithm may be trained using comprehensive scores of an athlete before and after finishing a training program. In this way, the machine learning algorithm may learn what training programs result in increased athlete performance.

Turning now to FIG. 7, a flowchart of a method 700 for outputting a comprehensive score based on one or more wellbeing categorical scores is shown. Method 700 may be included in a comprehensive score module, such as comprehensive score module 128. The comprehensive score may be a single quantitative metric that encompasses a physical ability (e.g., performance potential or performance readiness) of an athlete. The comprehensive score may be used to compare between athletes with similar characteristics and/or to track progress of an individual athlete.

In some examples, the comprehensive score may be a score of a team or a score of a subgroup of subjects within the team. For example, the one or more wellbeing categorical scores of each member of a team or subgroup may be combined to provide a quantitative metric that reflects average physical ability of the group of individuals. Additionally or alternatively, wellbeing categorical scores of each member of a team or subgroup of the team may be combined to reflect the total physical ability of the group of individuals. The comprehensive score of the group may be used to track the progress of the group or to compare progress of subgroups within the group.

As a further example, each individual of a group of individuals (e.g., a team) may receive an individual comprehensive score. A sub-group within the team may be generated by the system based on similarities in wellbeing scores (e.g., a sub-group may have similar biomechanical deficiencies). A single training program or set of training programs may then be output for the sub-group. In this way the generation of the training program may be performed at the aggregate group level. Grouping in this way before generating training programs may decrease the memory and processing demand of the system while still providing useful outputs at both the group and individual level.

At 702, method 700 includes receiving one or more wellbeing categorical scores. The one or more wellbeing categorical scores may include categorical scores received from a wellbeing categorical score module of a training application. The one or more wellbeing categorical scores may include biomechanical scores calculated by a biomechanical score submodule as described above with respect to method 300 of FIG. 3. Optionally, at 704, method 700 includes retrieving user characterization input (e.g., user characterization input 202) including answers to a survey evaluation (e.g., survey evaluation 204b). The user characterization input may be stored in memory of the user device and/or the central server.

At 706, method 700 includes weighting the one or more wellbeing categorical scores including biomechanical scores. Each of the one or more wellbeing categorical scores may be weighted differently. Weighting may be applied to the test scores that comprise the one or more wellbeing categorical scores. Additionally or alternatively, weighting may be applied to the determined wellbeing category. In some examples, weighting may be determined based on a rules based algorithm. In examples where user characterization input is received, the weighting may depend on characteristics such as sex, age, and sport of the athlete. In other examples, the weighting may depend on the inputs into the one or more wellbeing categorical scores. In some examples, the weighting may be determined by a machine learning and/or artificial intelligence algorithm. The machine learning and/or artificial intelligence algorithm may be trained using pairs of comprehensive scores and re-test outcomes to determine which weight most accurately reflects improvements in athlete performance.

At 708, method 700 includes calculating a comprehensive score based on the weighted one or more wellbeing categorical scores, including the biomechanical score. Optionally, at 709, in addition to calculating a comprehensive score, an adapted comprehensive score is also calculated. In such examples, a comprehensive score may not include weighting based on user characterization, while the adapted comprehensive score includes the weighting based on the user characterization. In this way the user may determine the comprehensive score of the athlete both generally as an athlete, and specifically based on the user characterization of the athlete. In some examples, the comprehensive score and/or the adapted comprehensive score may be assigned on a scale of 0 to 100.

At 710, method 700 includes storing and outputting the comprehensive score to a user device. In some examples, the user device and/or the central server may store the comprehensive score in a memory. The stored comprehensive score may be referred to after updated one or more wellbeing categorical scores and a subsequent updated comprehensive score are determined for an athlete. Additionally, in examples where an adapted comprehensive score is calculated, the method may include at 711 storing and outputting the adapted comprehensive score to the user device. In this way, an objective progression or regression of the athlete may be tracked. Additionally or alternatively, the user may compare the athletes to other athletes having a similar user characterization based on the comprehensive score. Further, the comprehensive score for one or more teams or other groups of subjects may be stored and output. In this way progress of teams or subgroups within a team may be tracked in addition to, or alternatively to individual athletes.

The technical effect of methods 300 and 700 is to automatically output a comprehensive score and individualized training program for an athlete or group of athletes comprising a team or subgroup of a team, in response to receiving video/pictures of the athlete performing movements captured on a non-specialized camera. The method further automatically incorporates user characterization data into the comprehensive score and the individualized training program. The methods make an objective evaluation, a normalized scoring system and an individualized training plan available without access to specialized movement capture cameras or sensors. Further, the system goes beyond generic computer processing to represent significant improvements to the functioning of computer systems with respect to generating individualized scoring and training plans. For example, the methods do not demand feedback from an expert user in order to output actionable results from the captured movements. The method may further use a one-to-one correspondence between the wellbeing categories to simplify data processing and decrease an overall computing power and memory demanded for the method. The comprehensive score and individualized training program may provide actionable instructions for increasing performance of an athlete and/or group of athletes and may recognize and improve on weaknesses to prevent an injury or reduce the occurrences of injury.

The disclosure also provides support for a system, comprising: a user device, a data collection device communicatively coupled to the user device, a processor configured with instructions stored on non-transitory memory that, when executed, cause the processor to: receive user characterization input of a subject, receive, from the data collection device, one or more of one or more evaluation movements of the subject captured by the data collection device and measured movement features, automatically output one or more biomechanical scores, each biomechanical score based on more than one measured movement features, output a comprehensive score based on the one or more biomechanical scores, the comprehensive score indicative of a physical ability of the subject, and output a training program, the training program individualized to the subject and configured to increase the comprehensive score of the subject. In a first example of the system, the data collection device is one or more of a native camera of a smartphone or tablet, a motion capture system, and a computer vision system, and instructions include to automatically identify and measure movement features from the one or more evaluation movements. In a second example of the system, optionally including the first example, instructions further include to receive one or more of survey evaluations and third party data. In a third example of the system, optionally including one or both of the first and second examples, the user characterization input includes physical traits of the subject and/or a survey evaluation, and wherein instructions further include to output a list of evaluation movements based on the received user characterization input. In a fourth example of the system, optionally including one or more or each of the first through third examples, instructions to output the training program include a machine learning algorithm configured to output the training program based on the one or more biomechanical scores. In a fifth example of the system, optionally including one or more or each of the first through fourth examples, the one or more biomechanical scores correspond to a strategy and a stability of an anatomical feature. In a sixth example of the system, optionally including one or more or each of the first through fifth examples, each of the one or more biomechanical scores further includes a left score and right score.

The disclosure also provides support for a method, comprising: assigning test scores to an athlete within one or more wellbeing categories based on inputs from one or more of movements recorded by a data collection device, survey evaluations, and third party data, determining one or more wellbeing categorical scores from the test scores, wherein each of the one or more wellbeing categorical scores are determined from the test scores of a corresponding category, calculating a comprehensive score based on the one or more wellbeing categorical scores, the comprehensive score indicating a physical ability of the athlete, outputting the comprehensive score to a display of a user device. In a first example of the method, the one or more wellbeing categorical scores includes one or more of a biomechanical score, a performance score, a skill score, a wellness score, a medical score, and a demographic score. In a second example of the method, optionally including the first example, determining the biomechanical score includes automatically identifying and measuring a plurality of movement features from a video or picture recorded by the data collection device. In a third example of the method, optionally including one or both of the first and second examples, identifying and measuring the plurality of movement features includes identifying one or more of an anatomical feature, measuring an angle, rates of change and ranges of lengths and angles. In a fourth example of the method, optionally including one or more or each of the first through third examples, the method further comprises: determining if each of the plurality of movement features are identified and measured, and response to each of the plurality of movement features not being identified and measured, requesting additional input from a user. In a fifth example of the method, optionally including one or more or each of the first through fourth examples, determining the one or more wellbeing categorical scores includes determining the one or more wellbeing categorical scores using a machine learning and/or artificial intelligence algorithm. In a sixth example of the method, optionally including one or more or each of the first through fifth examples, the method further comprises: outputting one or more training programs each of the one or more training programs based on one of the one or more wellbeing categorical scores. In a seventh example of the method, optionally including one or more or each of the first through sixth examples, the method further comprises: assigning new test scores after the athlete completes the one or more training programs. In an eighth example of the method, optionally including one or more or each of the first through seventh examples, the new test scores and completed training program are used to train a machine learning and/or artificial intelligence algorithm configured to output new training programs based on the one or more wellbeing categorical scores.

The disclosure also provides support for a method, comprising: determining one or more biomechanical scores from user evaluation movements of an athlete, weighting the one or more biomechanical scores, calculating a comprehensive score from the weighted biomechanical scores, storing the comprehensive score, and determining a progress of the athlete based on a change in the comprehensive score. In a first example of the method, weighting the one or more biomechanical scores is based on a user characterization input, and wherein the user characterization input includes one or more of a weight, sex, height, and sport of the athlete. In a second example of the method, optionally including the first example, the method further comprises: determining a relative ability of the athlete relative to a second athlete based on comparing the comprehensive score of the athlete to a comprehensive score of the second athlete. In a third example of the method, optionally including one or both of the first and second examples, weighting the one or more biomechanical scores includes weighting based on an output of a machine learning algorithm.

The disclosure provides further support for a method of using artificial intelligence to output a training program comprising training, by a computer, the artificial intelligence based on input data and a selected training algorithm to generate a trained artificial intelligence, wherein the selected training algorithm includes algorithms to compare wellbeing category scores before and after the training program; detecting one or more components of the training program and determining the unbeneficial components associated with a decrease in a wellbeing category score of the wellbeing category scores and dropping the unbeneficial components from a next training program.

It will be appreciated that the configurations and/or approaches described herein are exemplary in nature, and that these specific embodiments or examples are not to be considered in a limiting sense, because numerous variations are possible. The subject matter of the present disclosure includes all novel and nonobvious combinations and sub-combinations of the various features, functions, acts, and/or properties disclosed herein, as well as any and all equivalents thereof.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any articles, devices, or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A system, comprising:
a user device;
a data collection device communicatively coupled to the user device;
a processor configured with instructions stored on non-transitory memory that, when executed, cause the processor to:
receive user characterization input of a subject;
receive, from the data collection device, one or more of one or more evaluation movements of the subject captured by the data collection device and measured movement features;
automatically output one or more biomechanical scores, each biomechanical score based on more than one measured movement features;
output a comprehensive score based on the one or more biomechanical scores, the comprehensive score indicative of a physical ability of the subject; and
output a training program, the training program individualized to the subject and configured to increase the comprehensive score of the subject.

2. The system of claim 1, wherein the data collection device is one or more of a native camera of a smartphone or tablet, a motion capture system, and a computer vision system, and the instructions include to automatically identify and measure movement features from the one or more evaluation movements received from the data collection device.

3. The system of claim 1, wherein instructions further include to receive one or more of survey evaluations and third party data.

4. The system of claim 1, wherein the user characterization input includes physical traits of the subject and/or a survey evaluation, and wherein instructions further include to output a list of evaluation movements based on the received user characterization input.

5. The system of claim 1, wherein instructions to output the training program include a machine learning algorithm configured to output the training program based on the one or more biomechanical scores.

6. The system of claim 1, wherein the one or more biomechanical scores correspond to a strategy and a stability of an anatomical feature.

7. The system of claim 1, wherein each of the one or more biomechanical scores further includes a left score and right score.

8. A method, comprising:
assigning test scores to an athlete within one or more wellbeing categories based on inputs from one or more of movements recorded by a data collection device, survey evaluations, and third party data;
determining one or more wellbeing categorical scores from the test scores, wherein each of the one or more wellbeing categorical scores are determined from the test scores of a corresponding category;
calculating a comprehensive score based on the one or more wellbeing categorical scores, the comprehensive score indicating a physical ability of the athlete;
outputting the comprehensive score to a display of a user device.

9. The method of claim 8, wherein the one or more wellbeing categorical scores includes one or more of a biomechanical score, a performance score, a skill score, a wellness score, a medical score, and a demographic score.

10. The method of claim 9, wherein determining the biomechanical score includes automatically identifying and measuring a plurality of movement features from a video or picture recorded by the data collection device.

11. The method of claim 10, wherein identifying and measuring the plurality of movement features includes identifying one or more of an anatomical feature, measuring an angle, rates of change and ranges of lengths and angles.

12. The method of claim 10, further comprising determining if each of the plurality of movement features are identified and measured, and response to each of the plurality of movement features not being identified and measured, requesting additional input from a user.

13. The method of claim 8, wherein determining the one or more wellbeing categorical scores includes determining the one or more wellbeing categorical scores using a machine learning and/or artificial intelligence algorithm.

14. The method of claim 8, further comprising outputting one or more training programs each of the one or more training programs based on one of the one or more wellbeing categorical scores.

15. The method of claim 14, further comprising assigning new test scores after the athlete completes the one or more training programs.

16. The method of claim 15, wherein the new test scores and completed training program are used to train a machine learning and/or artificial intelligence algorithm configured to output new training programs based on the one or more wellbeing categorical scores.

17. A method, comprising:
determining one or more biomechanical scores from user evaluation movements of an athlete;
weighting the one or more biomechanical scores;
calculating a comprehensive score from the weighted biomechanical scores;
storing the comprehensive score; and
determining a progress of the athlete based on a change in the comprehensive score.

18. The method of claim 17, wherein weighting the one or more biomechanical scores is based on a user characterization input, and wherein the user characterization input includes one or more of a weight, sex, height, and sport of the athlete.

19. The method of claim 17, further comprising determining a relative ability of the athlete relative to a second athlete based on comparing the comprehensive score of the athlete to a comprehensive score of the second athlete.

20. The method of claim 17, wherein weighting the one or more biomechanical scores includes weighting based on an output of a machine learning algorithm.
